(19) United States
(12) Patent Application Publication
(10) Pub. No.: US 2015/0033931 A1
(43) Pub. Date: Feb. 5, 2015

(54) ACOUSTIC MUSICAL INSTRUMENT

(71) Applicant: Man-Tian FENG, Beijing City (CN)

(72) Inventor: Man-Tian FENG, Beijing City (CN)

(21) Appl. No.: 14/083,831

(22) Filed: Nov. 19, 2013

(30) Foreign Application Priority Data
Jul. 31, 2013 (TW) 102214382

(51) Int. Cl. G10D 9/02

(52) U.S. Cl. CPC G10D 9/02
USPC 84/398; 84/330

(57) ABSTRACT

An acoustic musical instrument includes a main body defining a resonance chamber, and a magnetic device mounted to the main body.

### CROSS-REFERENCE TO RELATED APPLICATION

This application claims priority of Taiwanese Application No. 102214382, filed on Jul. 31, 2013.

### BACKGROUND OF THE INVENTION

1. Field of the Invention

The invention relates to an acoustic musical instrument, more particularly to an acoustic musical instrument provided with a magnetic device for improving timbre thereof.

2. Description of the Related Art

Wind instruments may be generally classified into two categories, namely, woodwind instrument and brass instrument. A wind instrument generally includes a mouthpiece and a tubular body that defines a resonance chamber therein. When a performer blows air into the resonance chamber through the mouthpiece to play the wind instrument, air inside the resonance chamber vibrates and resonates to produce sound. However, when playing the wind instrument in a concert hall, electronic equipment in the concert hall and cell phones of audience may lead to electromagnetic interference, and thus adversely affect the sound produced by the wind instrument.

### SUMMARY OF THE INVENTION

The object of the present invention is to provide an acoustic musical instrument capable of reducing airborne electromagnetic interference and noise in the ambient.

According to the present invention, there is provided an acoustic musical instrument including a main body that defines a resonance chamber and a magnetic device that is mounted to the main body.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a first preferred embodiment of an acoustic musical instrument according to the present invention, where a magnetic device is mounted on an outer surface of the acoustic musical instrument;

FIG. 2 is a fragmentary partly sectional view illustrating a modification of the magnetic device of the first preferred embodiment, where the magnetic device is mounted on an inner surface of the acoustic musical instrument;

FIG. 3 is a perspective view of another modification of the magnetic device of the first preferred embodiment, where a plurality of keys of the acoustic musical instrument serve as the magnetic device;

FIG. 4 is a perspective view of yet another modification of the magnetic device of the first preferred embodiment, where joints between tubular members that constitute the acoustic musical instrument serve as the magnetic device; and

FIG. 5 is a perspective view of a second preferred embodiment of the acoustic musical instrument according to the present invention.

### DETAILED DESCRIPTION OF THE PREFERRED EMBODIMENTS

Before the present invention is described in greater detail, it should be noted that like reference numerals are used to indicate corresponding or analogous elements throughout the accompanying disclosure.

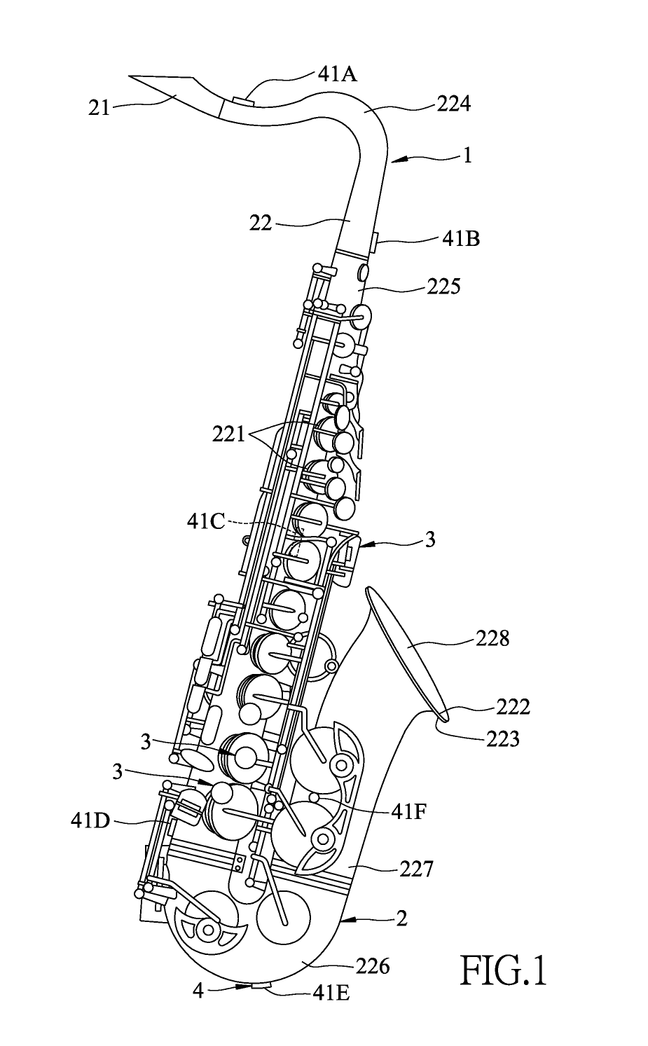

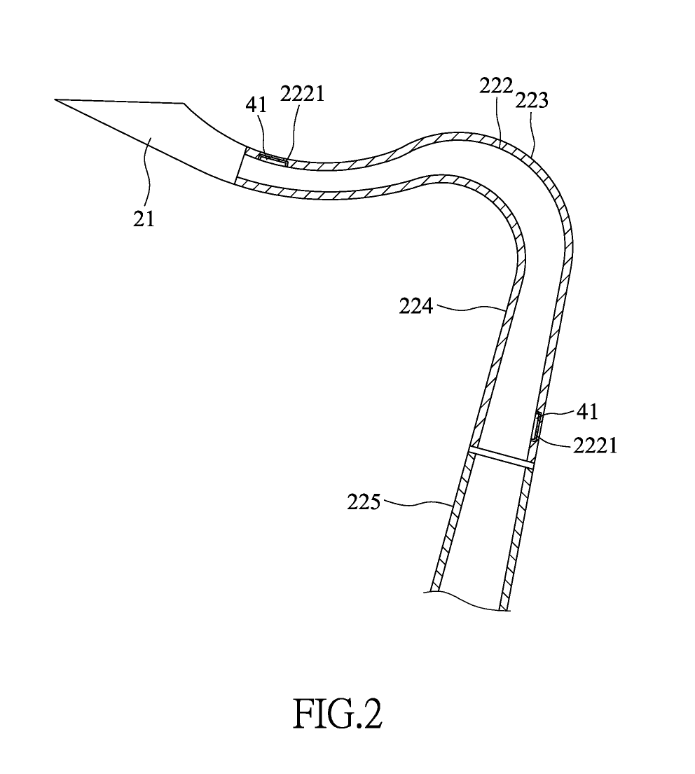

Referring to FIGS. 1 and 2, the first preferred embodiment of the acoustic musical instrument 1 according to the present invention is shown to include a main body 2, a plurality of keys 3, and a magnetic device 4. In this embodiment, the acoustic musical instrument 1 is a curved saxophone but may be a straight saxophone in other embodiments of this invention.

The main body 2 includes a mouthpiece 21 and a tubular unit 22. The tubular unit 22 has an outer surface 223 and an inner surface 222 defining a resonance chamber 228 in the tubular unit 22, is connected to the mouthpiece 21, and is formed with a plurality of through holes 221 in spatial communication with the resonance chamber 228. Further, the tubular unit 22 includes a neck member 224, a tubular member 225, a U-shaped bow member 226, and a bell member 227. The neck member 224 is connected to the mouthpiece 21. The tubular member 225 is connected to the neck member 224 opposite to the mouthpiece 21. The U-shaped bow member 226 is connected to the tubular member 225 opposite to the neck member 224. The bell member 227 is connected to the bow member 226 opposite to the tubular member 225. The keys 3 are disposed at the tubular member 225, and are user-operable to cover the through holes 221, respectively.

The magnetic device 4 is a permanent magnet or an electromagnet, and includes a plurality of magnetic elements 41A-41F. The magnetic elements 41A, 41B are mounted respectively to opposite ends of the neck member 224 that are respectively near the mouthpiece 21 and the tubular member 225. The magnetic element 41C is mounted to a middle portion of the tubular member 225. The magnetic element 41D is mounted to the tubular member 225 near a joint between the tubular member 225 and the bow member 226, the magnetic elements 41E is mounted to an intermediate portion of the bow member 226, and the magnetic element 41F is mounted to the bell member 227.

In this embodiment, the magnetic elements 41A-41F are mounted on the outer surface 223 of the tubular unit 22. It should be noted that, in a modification of this embodiment shown in FIG. 2, the inner surface 222 of the tubular unit 22 may be formed with a plurality of recesses 2221 for receiving the magnetic elements 41A-41F, respectively.

When a performer plays the acoustic musical instrument 1, air flows into the resonance chamber 228 through the mouthpiece 21 and air column inside the resonance chamber 228 vibrates and resonates to produce sound. The magnetic device 4 generates magnetic fields to alleviate interference from electromagnetic wave generated by electronic equipment nearby and cell phones of audience, so as to stabilize vibration and resonation of the air column. As a result, the acoustic musical instrument 1 may produce the sound with a relatively stable amplitude and a relatively stable and round timbre. Additionally, hash noises in the ambient may also be alleviated, such that attenuation of the sound wave when propagating in the air can be reduced and a relatively pure timbre can be obtained. It should be noted that the acoustic musical instrument 1 may be a wind instrument, a woodwind instrument, or a bass instrument as long as it has a resonance chamber.

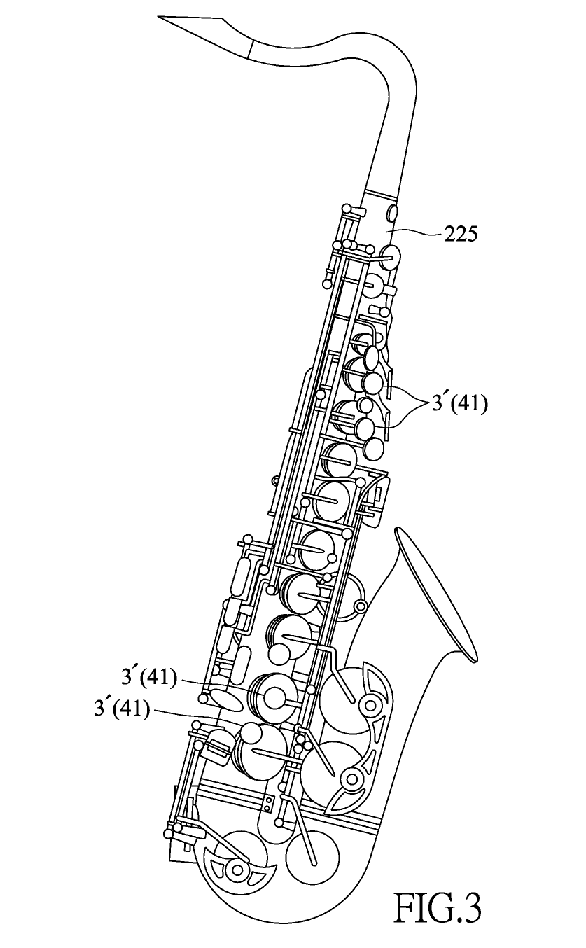

Referring to FIG. 3, another modification of the acoustic musical instrument 1 of the first preferred embodiment is shown. In this modification, the keys 3′ are made of a magnetic material, and serve as the magnetic elements 41 of the magnetic device 4, respectively. The keys 3′ can provide the same advantages of improving timbre of the acoustic musical instrument 1 since the keys 3′ are connected to the tubular member 225.

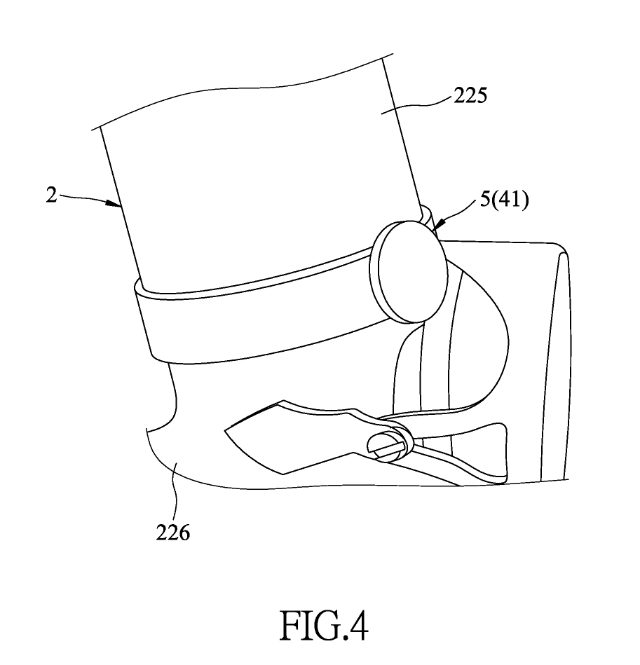

As shown in FIG. 4, yet another modification of the acoustic musical instrument 1 is shown. Since the acoustic musical instrument 1 is usually assembled from a plurality of tubular components that have uneven thicknesses, undesired vibration at the joints between every two adjacent tubular components adversely affects sound production of the acoustic musical instrument 1. The magnetic device 4 in this modification includes a plurality of magnetic elements 41 that serve as a joint 5 between the neck member 224 and the tubular member 225, a joint 5 between the tubular member 225 and the bow member 226, and a joint 5 between the bow member 226 and the bell member 227. Note that any joint 5 for joining the tubular components constituting the main body 2 of the acoustic musical instrument 1 may serve as the magnetic element 41.

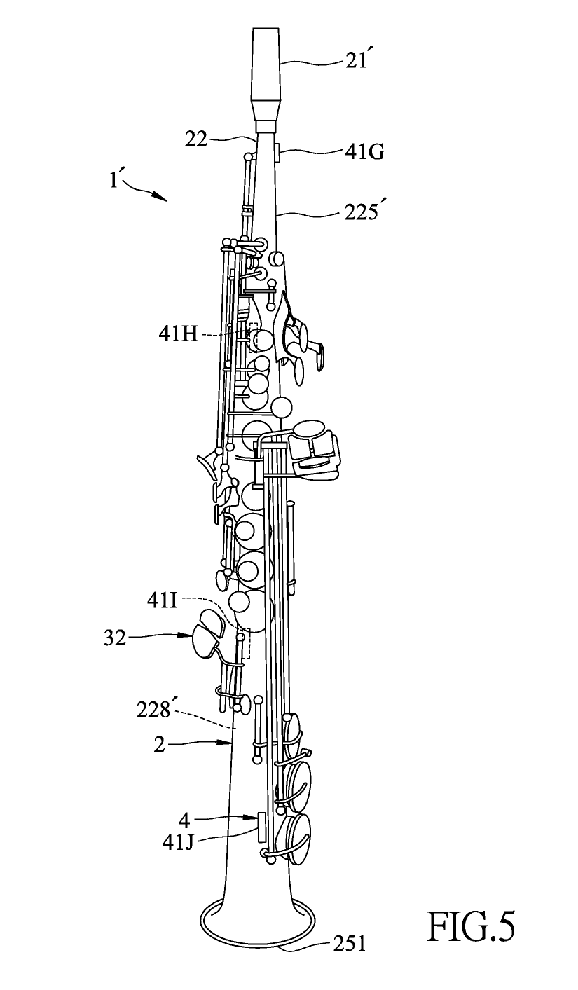

Referring to FIG. 5, a second preferred embodiment of the acoustic musical instrument 1′ is shown. The main difference between this embodiment and the first embodiment resides in the following. In this embodiment, the acoustic musical instrument 1′ is a straight saxophone and includes a mouthpiece 21′ and a tubular member 225′. The tubular member 225′ defines the resonance chamber 228′ therein and has a flared end 251 opposite to the mouthpiece 21′. The magnetic device 4 includes four magnetic elements 41G, 41H, 41I, and 41J. Two of the magnetic elements 41G, 41J are mounted respectively to opposite ends of the tubular member 225′ near the mouthpiece 21′ and the flared end 251. The remaining two magnetic elements 41H, 41I are mounted to a middle portion of the tubular member 225′ between the magnetic elements 41G and 41J. It should be noted that the number and the positions of the magnetic elements 41 are not limited to this disclosure and may vary according to the actual configuration of the acoustic musical instrument 1.

To sum up, by virtue of the magnetic device 4, vibration and resonation of the air column in the resonance chamber 228 are stabilized, such that the acoustic musical instrument 1 may produce a relatively stable and round timbre. Furthermore, hash noises in the ambient may reduced when playing the acoustic musical instrument 1, such that the sound wave generated by the acoustic musical instrument 1 may propagate a relatively long distance.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An acoustic musical instrument comprising:
a main body defining a resonance chamber; and
a magnetic device mounted to said main body.

2. The acoustic musical instrument as claimed in claim 1, wherein said acoustic musical instrument is a wind instrument.

3. The acoustic musical instrument as claimed in claim 1, wherein said acoustic musical instrument is a woodwind instrument.

4. The acoustic musical instrument as claimed in claim 1, wherein said main body includes a mouthpiece and a tubular unit that is connected to said mouthpiece and that defines said resonance chamber therein,
wherein said magnetic device is mounted to said tubular unit near said mouthpiece.

5. The acoustic musical instrument as claimed in claim 4, wherein said tubular unit includes:
a neck member connected to said mouthpiece;
a tubular member connected to said neck member opposite to said mouthpiece;
a U-shaped bow member connected to said tubular member opposite to said neck member; and
a bell member connected to said bow member opposite to said tubular member;
wherein said magnetic device includes at least two magnetic elements, one of said magnetic elements is mounted to said neck member, and the other one of said magnetic elements is mounted near one of a joint between said neck member and said tubular member, a joint between said tubular member and said bow member, and a joint between said bow member and said bell member.

6. The acoustic musical instrument as claimed in claim 1, further comprising a plurality of keys that are disposed at said main body, that are made of a magnetic material, and that serve as said magnetic device.

7. The acoustic musical instrument as claimed in claim 1, wherein said main body includes at least two members connected to each other, and said acoustic musical instrument further comprises at least one joint member that is disposed at said main body for interconnecting said members of said main body, that is made of a magnetic material, and that serves as said magnetic device.

8. The acoustic musical instrument as claimed in claim 4, wherein said tubular unit of said main body has an inner surface and an outer surface, and said magnetic device is mounted on one of said inner and outer surfaces.

9. The acoustic musical instrument as claimed in claim 1, wherein said magnetic device is one of a permanent magnet and an electromagnet.
